(19) United States
(12) Patent Application Publication
(10) Pub. No.: US 2024/0430970 A1
(43) Pub. Date: Dec. 26, 2024

(54) TECHNIQUES FOR SESSION MANAGEMENT SIGNALING FOR PARTIAL NETWORK SLICE SUPPORT IN A REGISTRATION AREA

(71) Applicant: Lenovo (Singapore) Pte. Ltd., New Tech Park (SG)

(72) Inventors: Genadi Velev, Darmstadt (DE); Roozbeh Atarius, La Jolla, CA (US)

(21) Appl. No.: 18/750,861

(22) Filed: Jun. 21, 2024

Related U.S. Application Data
(60) Provisional application No. 63/510,048, filed on Jun. 23, 2023.

(51) Int. Cl. H04W 76/20; H04W 4/12; H04W 48/18; H04W 64/00

(52) U.S. Cl. CPC H04W 76/20; H04W 4/12; H04W 48/18; H04W 64/00

(57) ABSTRACT

Various aspects of the present disclosure relate to techniques for session management signaling for partial network slice support in a registration area. An apparatus is configured to receive a first session management (SM) message for a protocol data unit (PDU) session associated with a network slice and a user equipment (UE), determine that the network slice is not supported or not available in a location area of the UE, and transmit a second SM message and an indication that the network slice is not supported or not available in the location area of the UE.

### TECHNICAL FIELD

The present disclosure relates to wireless communications, and more specifically to techniques for session management signaling for partial network slice support in a registration area.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may include means for transmitting signaling for a session management (SM) procedure for an established protocol data unit (PDU) session associated with a network slice, wherein the network slice is not supported or not available in a location area of the UE, receiving a non-access stratum (NAS) SM message as part of the SM procedure for the PDU session, and performing an action according to the NAS SM message without initiating activation of user plane resources for the PDU session.

In some implementations of the method and apparatuses described herein may include means for receiving a first SM message for a PDU session associated with a network slice and a UE, means for determining that the network slice is not supported or not available in a location area of the UE, means for transmitting a second SM message and an indication that the network slice is not supported or not available in the location area of the UE.

### BRIEF DESCRIPTION OF THE DRAWINGS

FIG. 1 illustrates an example of a wireless communications system in accordance with aspects of the present disclosure.

FIG. 2 illustrates an example of a system setup for network slicing and a specific UE request in accordance with aspects of the present disclosure.

FIG. 3 illustrates an example signal flow for a UE-initiated NAS SM signaling procedure for a PDU session in accordance with aspects of the present disclosure.

FIG. 4 illustrates an example signal flow for a network-initiated NAS SM signaling procedure for a PDU session in accordance with aspects of the present disclosure.

FIG. 5 illustrates an example signal flow to reject the activation of user plane (UP) resources of a PDU session when the UE is outside the support/availability of the single network slice selection assistance information (S-NSSAI) in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a network equipment (NE) in accordance with aspects of the present disclosure.

FIG. 9 illustrates a flowchart of a method performed by a UE in accordance with aspects of the present disclosure.

FIG. 10 illustrates a flowchart of a method performed by a NE in accordance with aspects of the present disclosure.

### DETAILED DESCRIPTION

In 5G networks, a network slice spans through a radio access network (RAN) and core network (CN), e.g., 5G core network (5GC). In general, a network slice can be deployed on a cell or tracking area (TA), which would fulfil the service requirements from the network slice customer/user who requested the network slice deployment. With the evolution of 5G and various deployments, e.g., non-public networks (NPN), there is a need to deploy some network slices in a single TA or a limited set of TAs. The network may have 1) network slices supported in all tracking areas (e.g. in the whole network coverage), 2) network slices supported in some tracking areas, or 3) network slices operating in a single TA.

Even if a network slice is supported in a single TA or a set of TAs, the network slice may be available as a single cell or a set of cells as part of the TA(s). The network slice “availability,” as used herein, may refer to the network resources (e.g., including radio resources, core network resources, and transport and computational resources) that are needed to fulfil the service requirements for the network slice. In such an embodiment, the network slice area of service (NS-AoS) does not match the deployed TAs where the network slices are supported. In other words, the single Network Slice Selection Assistance Information (S-NSSAI) location availability information defines additional restrictions to the usage of an S-NSSAI in TAs where the network slice availability does not match the TA boundaries.

According to 5G specifications, e.g., in 3GPP TS 23.501 V18.1.0 and TS 23.502 V18.2.0 (both incorporated herein by reference), the 5GC creates and configures the UE with a set of allowed network slices, i.e., identified by allowed NSSAI, which is described as the S-NSSAIs of the allowed NSSAI are available in all TAs of the registration area (RA). Neighboring TAs that support the allowed NSSAI may be allocated into the same RA.

The UE may also be configured with a set of partially allowed network slices, e.g., partially allowed NSSAI, which indicates the S-NSSAIs values the UE could use in the serving public land mobile network (PLMN) or standalone non-public network (SNPN) in some of the TAs in the current RA. Each S-NSSAI in the partially allowed NSSAI is associated with a list of TAs where the S-NSSAI is supported.

Such network slice configuration is sent to the UE using a NAS registration accept message or NAS UE configuration update command message. The Access and Mobility Management Function (AMF) may, in addition to the partially allowed NSSAI, also include corresponding mapping information of the S-NSSAI(s) of the partially allowed NSSAI to the HPLMN S-NSSAI(s).

When the AMF creates an RA with one or more TAs, the S-NSSAIs of the allowed NSSAI are supported in the TAs of the RA. If the UE's requested NSSAI contains an S-NSSAIs that is supported in the current TA but not supported in other TAs of a possible RA, the AMF may create an RA that is suitable considering the anticipated paging load versus the load generated due to mobility registration update (MRU) requests and the AMF includes the S-NSSAI in the partially allowed NSSAI. An additional assistance information is associated with the S-NSSAI indicating a list of TAs where the S-NSSAI is supported.

The 5GC (e.g., AMF) may send to the UE in the registration accept message (in case of UE registration procedure) or in UE configuration update command message (in case of UE configuration update procedure) one or more of the following elements related to the network slice configuration of the UE-allowed NSSAI, partially allowed NSSAI configured NSSAI, rejected NSSAI, or pending NSSAI. The NSSAI is a list of one or more S-NSSAIs. Each S-NSSAI of the partially allowed NSSAI may be associated with a list of TAs (which are a subset of the list of TAIs forming the RA) where the S-NSSAI is supported.

However, it may not be clear whether the UE or the network may release or modify the PDU session. If the UE sends an UL NAS TRANSPORT message including a 5G SM message associated with an S-NSSAI, the AMF may not know the type of the SM message, e.g., whether to activate UP resources or to release the PDU session. The AMF does not know whether to reject the NAS transport procedure (e.g., to reject the NAS mobility management (MM) Transport message) or forward the NAS SM message to the Session Management Function (SMF).

Current specifications may not allow activation of the UP resources in TAs outside the list of TAs where the S-NSSAI is supported. However, the behavior for the PDU session management procedure, e.g., for the SM signaling to control the PDU session context in the UE and the SMF (e.g., for PDU session release or modification) is not specified.

In other words, when a network slice is part of the partially allowed NSSAI, the UE may not activate the UP resources for any PDU session associated with the S-NSSAI. However, there are no solutions that describe the UE and the network (e.g., AMF or SMF) behavior when SM for such PDU session(s) is to be performed.

In response to the foregoing, the following solutions are proposed. In one embodiment, at a UE location in the RA, the UE or the network (e.g., AMF or SMF) may initiate and perform an SM procedure (e.g., 5G SM message transmission procedure) for an established PDU session when the associated S-NSSAI is included in the partially allowed NSSAI or if NS-AoS for the S-NSSAI applies (e.g., is configured) so that the NAS SM procedure can be performed independently whether in the RA where 1) the UE is located in an area where the S-NSSAI is supported or available, or 2) the UE is located in an area where the S-NSSAI is not supported or not available. Aspects of the present disclosure are described in the context of a wireless communications system.

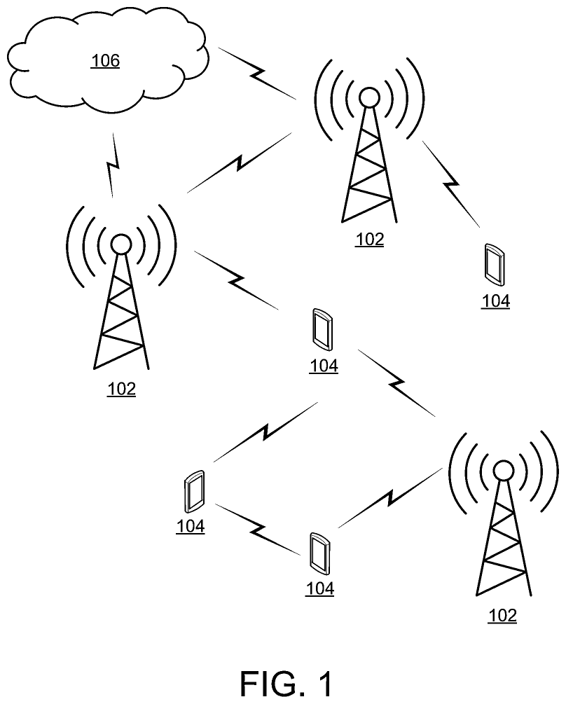

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a RAN, a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a PDU session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., (=2), which includes 60 kHz subcarrier spacing; and a fourth numerology (e.g., μ=3), which includes 120 kHz subcarrier spacing.

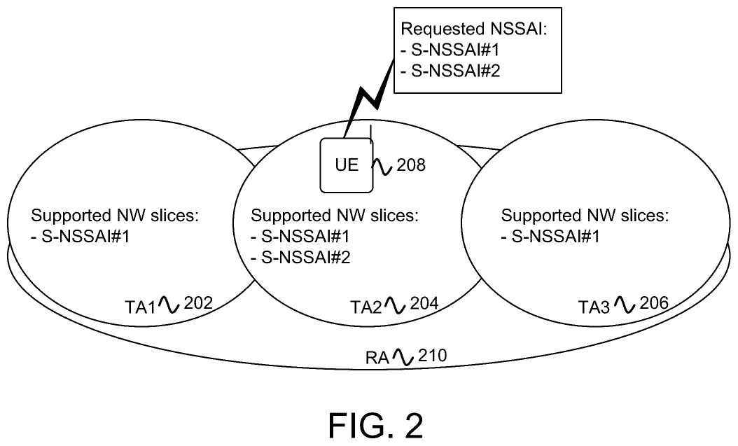

FIG. 2 illustrates an example of a system setup for network slicing and a specific UE request in accordance with aspects of the present disclosure. In particular, FIG. 2 illustrates one example of deployment with TA1 202, TA2 204, and TA3 206. The TA1 202 supports S-NSSAI #1, the TA2 204 supports S-NSSAI #1 and S-NSSAI #2; and the TA3 206 supports S-NSSAI #1. The UE 208 is located in TA2 204 and sends a requested NSSAI containing S-NSSAI #1 and S-NSSAI #2. The 5GC (e.g. AMF and/or NSSF) considers that the UE 208 is currently located in TA2 204 and the TA2 204 supports S-NSSAI #1 and S-NSSAI #2, whereas the neighbor TA1 202 and TA3 206 support only S-NSSAI #1. Therefore, the AMF may assign an RA 210 including TA1 202, TA2 204 and TA3 206 and the AMF sends to the UE 208 a registration accept message including RA 210, TA1 202, TA2 204, TA3 206; Allowed NSSAI that includes S-NSSAI #1; Partially allowed NSSAI that includes S-NSSAI #2, an associated list of TAs where the S-NSSAI #2 is supported and includes TA2 204 only; and rejected NSSAIs, which include none.

When the UE 208 has already established a PDU session with an S-NSSAI part of the partially allowed NSSAI, the UE 208 is allowed to activate the UP Resources of the PDU session only when the UE 208 is in a TA part of the list of TAs (where the S-NSSAI is supported) associated with each S-NSSAI.

However, it is not clear whether the UE or the network may initiate and perform session management procedure (e.g. release or modify procedures) for the established PDU session if the UE in outside the list of TAs (where the S-NSSAI is supported) or if the UE is outside of the of S-NSSAI availability area (e.g. Network Slice Area of Service). If the UE sends UL NAS TRANSPORT message including a 5GSM message associated with an S-NSSAI, the AMF doesn't know the type of the SM message, i.e. whether to activate UP resources or to release the PDU session. The AMF does not know whether to reject the NAS transport procedure (e.g. reject the NAS MM Transport message) or forward the NAS SM message to the SMF.

The following describes solutions for the foregoing problems with the current state of the art. For the solutions described herein, please note that in this disclosure the term ‘support’ of an S-NSSAI means that the S-NSSAI is deployed in an area like tracking area (TA) which is related to the network slicing feature called “Partial Network Slice support in a Registration Area”. On the other hand, the term ‘available’ S-NSSAI means that enough resources are allocated for the S-NSSAI in the given area like a set of cells, which is related to the network slicing feature called “Network Slice Area of Service not matching deployed Tracking Areas”. In other words, a network slice (e.g. S-NSSAI is used interchangeably with network slice) can be supported in a TA (e.g. in all cells of the TA), but the S-NSSAI may be available only in one or more cells of the TA where enough network resources are allocated to fulfil the service requirements of the network slice. Such area of S-NSSAI availability is called NS-AoS. In other cells outside the NS-AoS, and within the TA where the S-NSSAI is supported, there might be zero or limited network (e.g. radio) resources allocated for the S-NSSAI. When the network slice availability does not match the TA boundaries, the AMF provides S-NSSAI location availability information which defines the restrictions where to use the S-NSSAI in TA(s). In this disclosure the NS-AoS) and the S-NSSAI location availability information (which is sent to the UE) are used interchangeably and include, for each applicable S-NSSAI of the configured NSSAI, location information indicating the cells of TAs in the RA where the S-NSSAI is available.

It may be assumed that an established PDU session, which is associated with an S-NSSAI which is part of the partially allowed NSSAI, is not released (i.e. not removed in the control plane) when the UE moves to an area outside the support of the S-NSSAI, but the user plane connection/resources are deactivated. In other words, the data radio bearer and the N3 (and or N9) transport tunnel are deactivated, but the PDU session context in the UE, AMF and SMF is kept established. The UE is allowed to initiate PDU session establishment for the S-NSSAI only when the UE is in a TA where the S-NSSAI is supported. When the UE has already established a PDU session with an S-NSSAI part of the Partially Allowed NSSAI, the UE is allowed to activate the User Plane Resources of the PDU session only when the UE is in a TA part of the list of TAs associated with each S-NSSAI, as described in more detail below.

In order to cover both network slicing features, i.e. “Partial Network Slice support in a Registration Area” and “Network Slice Area of Service not matching deployed Tracking Areas”, the disclosure uses the phrase outside/inside the area of support or availability of the S-NSSAI where inside the area of support of the S-NSSAI means that the current TA of the UE is part of the TA list where the S-NSSAI is supported, outside the area of support of the S-NSSAI means that the current TA of the UE is NOT part of the TA list where the S-NSSAI is supported, inside the area of availability of the S-NSSAI means that the current UE location is part of the NS-AoS associated with S-NSSAI, and outside the area of availability of the S-NSSAI means that the current UE location is outside of the NS-AoS associated with S-NSSAI.

From a UE perspective, if the UE is registered with an S-NSSAI having limited area of support or availability and the UE has already established a PDU session associated with the S-NSSAI (e.g. assuming that the PDU session UP resources are deactivated currently), when the UE is outside the area of support or availability of the S-NSSAI, the UE may initiate an SM signaling procedure to modify or release the SM context of the PDU session. The UE may send UL NAS Transport message including a 5GSM message associated with an S-NSSAI even in the following cases: (1) when the S-NSSAI is part of the partially allowed NSSAI and the current TA1 is not in the list of TAs where the S-NSSAI is supported or (2) when the S-NSSAI associated with location availability information and the current cell (where the UE is camping) is outside the location information of the S-NSSAI. Correspondingly for network initiated SM procedure, the UE can receive and process the NAS SM (or 5GSM) message outside the area of support or availability of the S-NSSAI.

From a network (e.g. AMF, SMF) perspective, when the AMF receives an UL NAS TRANSPORT message, the AMF terminates the message and if the payload is an N1 SM container (i.e. NAS SM message), the AMF may transmit the NAS SM message to the SMF and include indication that the S-NSSAI not supported in the current UE location (i.e. in the current TA). The SMF determines that the NAS SM message (e.g. N1 SM container) requires modification or release of the SM context, but based on the include indication that the S-NSSAI not supported in the current UE location the SMF determines to not activate the UP resources. The SMF processes the SM message, e.g. release the PDU session or modify the PDU session, but the SMF doesn't initiate UP resource (or connection) activation.

Please note that the terms “N1 SM message”, “N1 SM container” or “NAS SM message” are interchangeably used herein. Similarly, the terms “N2 SM message” and “N2 SM container” are interchangeably used.

In a first embodiment, the scenario is considered where a UE may request a NAS SM procedure for an established PDU session wherein the UE may happen to be located in an area where the PDU session's S-NSSAI is not supported or not available.

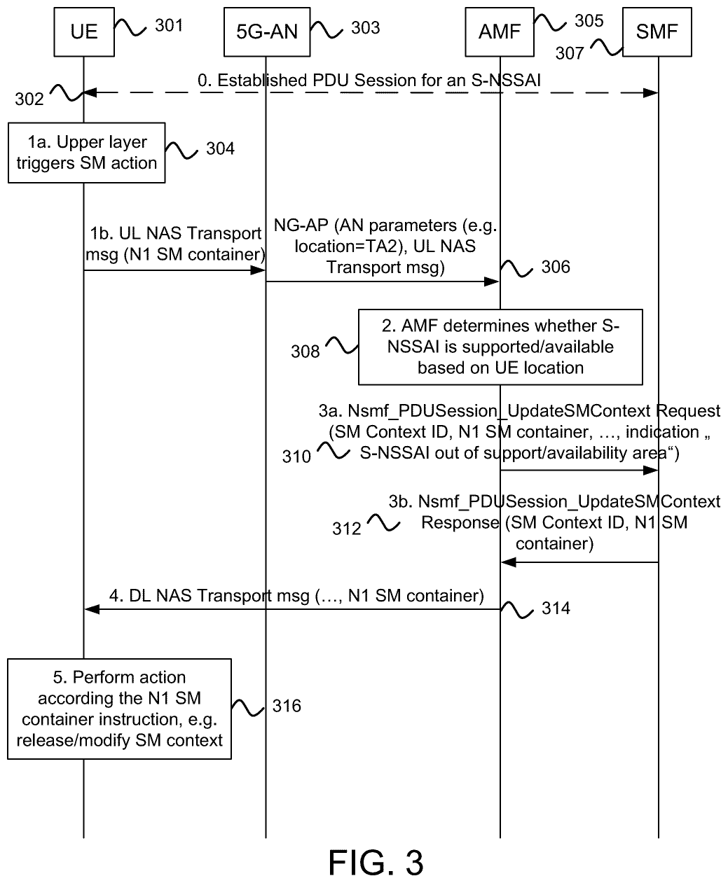

FIG. 3 illustrates an example signal flow for a UE-initiated NAS SM signaling procedure for a PDU session in accordance with aspects of the present disclosure. In particular, FIG. 3 shows a call flow for the scenario where the UE initiates NAS SM procedure for a PDU session associated with an S-NSSAI wherein the UE is outside the area of support or availability of the S-NSSAI.

At 0 (see messaging 302), there is a PDU session established between the UE 301 and the SMF 307. The PDU session is associated with an S-NSSAI (1) which is partially supported in the RA (e.g. the A-NSSAI is part of the partially allowed NSSAI) or (2) which is associated with location availability information or NS-AoS information (e.g. the S-NSSAI Area of Service not matching deployed Tracking Areas).

At 1a (see block 304), the upper layers in the UE 301, or the NAS Session Management sub-layer, may trigger an SM action for an established PDU session. For example, an existing PDU may need to be released (e.g. UE initiated PDU session release) or the modified (e.g. a multi-access PDU session, MA PDU session, may need to be modified to release or establish a leg over a specific access).

The UE 301 considers (e.g. evaluates) the current location, meaning whether the UE 301 is currently 1) in a TA which support the S-NSSAI associated with the PDU session, or 2) in a cell which is outside or inside the NS-AoS. The UE 301 may be either in a Connected state or in Idle state and camping in the cell. Even when the UE 301 is located in area where the S-NSSAI associated with the PDU session (for which the SM procedure is triggered) is not supported or not available, the UE 301 may proceed with the SM procedure for the PDU session.

At 1b (see messaging 306), the UE 301 initiates an SM procedure (e.g. a 5GSM procedure) for the already established PDU session. If the PDU session is associated with an S-NSSAI and the UE 301 is currently located in area where the S-NSSAI is not supported or available, the UE 301 should not block the SM procedure and the UE 301 (i.e. the NAS MM sub-layer) should proceed with sending the SM signaling to the SMF 307. If there is UL data stored or pending in the UE 301, the UE 301 should not use a service request procedure to include the PDU session in the list of PDU sessions to be activated. Rather, the UE 301 should trigger a NAS transport procedure to transmit the NAS SM message. For example, the UE 301 may create an UL NAS TRANSPORT message that contains payload container type IE indicating a single 5GSM message. Further the UL NAS TRANSPORT message may contain PDU session information like PDU session ID, S-NSSAI, etc.

The UE 301 sends the UL NAS TRANSPORT message to the 5G-AN 303 encapsulated in a radio resource control (RRC) message. The 5G-AN 303 takes the UL NAS TRANSPORT message and encapsulates in N2 NG-AP message to the AMF 305. The NG-AP message includes AN parameters and the UL NAS TRANSPORT message. The AN parameters include parameters from the access network to the AMF 305, e.g. RRC establishment cause, 5G-S-TMSI or GUAMI, the cell ID or TA1 (from which the UE 301 initiates the NAS signaling.

At 2 (see block 308), the AMF 305 receives the NG-AP message. If the UL NAS TRANSPORT message includes N1 SM container (or NAS SM message), the AMF 305 may need to evaluate whether the S-NSSAI associated with the related PDU session is subject is part of the partially allowed NSSAI or whether the S-NSSAI is associated with NS-AoS information. If this is the case, the AMF 305 takes into account the UE's 301 location (e.g. current TA or cell ID) and the AMF 305 determines whether 1) the UE's 301 current TA supports the S-NSSAI, or 2) the UE's 301 current cell is included in the NS-AoS. If the support/validity criteria for the S-NSSAI are met, then the AMF 305 proceeds as normal to transmit the NAS SM message to the corresponding SMF 307. If the support/validity criteria for the S-NSSAI are not met, then the AMF 305 decides to transmit the NAS SM message to the corresponding SMF 307 and includes in addition an indication that the UE 301 is outside the support or availability area for the S-NSSAI. The latter indication can be called e.g., “S-NSSAI out of support/availability area”.

At 3a (see messaging 310), the AMF 305 creates and sends an N11 message to the SMF 307 whereas the NAS SM message is encapsulated within the N11 message. For example, the AMF 305 may use Nsmf_PDUSession_UpdateSMContext Request service operation and include in the message at least one of SM Context ID, N1 SM container, indication “S-NSSAI out of support/availability area”.

The indication “S-NSSAI out of support/availability area” is included in order to indicate to the SMF 307 that the UP resources of the PDU session cannot be activated in the current UE 301 location. For example, if the SMF or UPF stores downlink (DL) data for transmission, then the SMF does not initiate the UP resource (or connection) activation but only processes the SM procedure.

At 3b (see messaging 312), the SMF 307 processes the received N1 SM container (e.g. NAS SM signaling message). The SMF 307 creates and sends to the AMF 305 a NAS SM signaling message encapsulated in an N11 message. For example, the SMF may use the Nsmf_PDUSession_UpdateSMContext Response service operation including at least one of: SM Context ID, PDU session ID, N1 SM container, etc.

At 4 (see messaging 314), the AMF 305 receives the N11 message containing the N1 SM container. The AMF 305 creates and sends to the UE 301 a DL NAS Transport message. The DL NAS Transport message is encapsulated in NG-AP message to the 5G-AN 303. The DL NAS Transport message includes the N1 SM container which contains the NAS SM message to the UE 301.

At 5 (see block 316), the UE 301 receives the DL NAS Transport message and extracts the NAS SM message. The NAS SM message is processed in the NAS SM instance of the NAS SM sub-layer. In general, the UE 301 performs action according the N1 SM container instruction, e.g. release/modify PDU session context. The UE 301 processes the SM message without initiating UP resource (or connection) activation. For example, if the NAS SM message indicates release of the PDU session, the UE NAS layer deletes the PDU session context internally.

In one embodiment, the benefit of the solution illustrated in FIG. 3 is that the UE 301 and the network (e.g. AMF 305, SMF 307) are enabled to perform an SM procedure for a PDU session when the UE 301 is located in area where the PDU session's S-NSSAI is either not supported or not available. Especially in case of PDU session release, such mechanism allows to clean-up the PDU session context in both the UE 301 and the network, which allows to effectively reduce the consumed resources (e.g. storage of PDU session context and associated possible signaling e.g. during UE 301 mobility).

In a second embodiment, the network (e.g. SMF) may request a NAS SM procedure for a PDU session wherein the UE may happen to be located in an area where the PDU session's S-NSSAI is not supported or not available. It is assumed that the UP resources/connection of the PDU session are not activated.

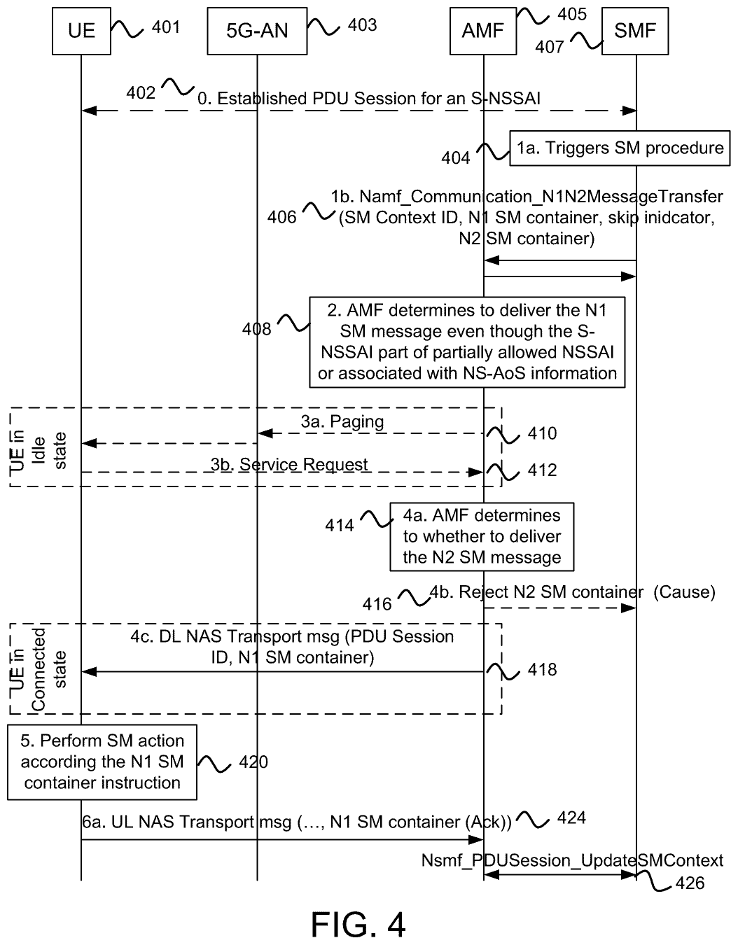

FIG. 4 illustrates an example signal flow for a network-initiated NAS SM signaling procedure for a PDU session in accordance with aspects of the present disclosure. As shown in FIG. 4, it is proposed that the network (e.g. SMF 407) initiate NAS SM signaling to the UE 401 and the AMF 405 determines to deliver/transmit the NAS SM message with a NAS transport procedure, although the UE 401 is outside the area of support or availability of the S-NSSAI.

At 0 (see messaging 402), a PDU session is established between the UE 401 and the SMF 407. In one embodiment, the SMF 407 may not be aware that the S-NSSAI of the PDU session has limited support in the RA or limited availability (i.e., the S-NSSAI is associated with an NS-AoS). In such an embodiment, the SMF 407 may initiate N1 SM signaling to the UE 401 or N2 SM signaling to the 5G-AN 403 (e.g., for activation of the UP resources). Then, when the SMF 407 sends to the AMF 405 a request including the N1 SM signaling or N2 SM signaling, it is up to the AMF 405 to determine whether to forward or to reject the SMF's 407 request. This is described in 2 below.

In another embodiment, the SMF 407 is aware that the S-NSSAI of the PDU session has limited support in the RA or limited availability (i.e. the S-NSSAI is associated with an NS-AoS). In such an embodiment, the SMF 407 may subscribe with the AMF 405 to be notified whether the UE 401 is inside or outside of an area of interest, wherein the area of interest is either 1) the list of TAs in the RA where the S-NSSAI is supported, or 2) the NS-AoS.

At 1a (see block 404), the SMF 407 determines to initiate an SM for an established PDU session. It is assumed that the UP resources are currently not activated. The SM procedure may be to modify the PDU session or to release the PDU session. The SMF 407 may determine to modify the PDU session, e.g. to configure new ATSSS rules for MA PDU session, or to inform the UE 401 of an Alternative S-NSSAI, to exchange update quality of service (QOS) parameters and/or to send updated ECS Address Configuration Information to the UE 401, or the like.

The SMF 407 may decide to release a PDU session based on various scenarios such as a locally configured policy (e.g. the release procedure may be related with the UPF re-allocation for SSC mode 2/mode 3), a timer expiration for inactivity of the PDU session, a timer expiration of the temporary available network slice, or a combination thereof. In one embodiment, the SMF 407 creates an N1 SM including either PDU session Modification Command message ( ) or PDU session Release Command message (PDU session ID, Cause).

At 1b (see messaging 406), the SMF 407 sends N1 SM message to the UE 401. The N1 SM message may be either PDU session Modification Command message (PDU session ID, QoS rule(s), QoS rule operation and QoSfFlow level QoS parameters operation, Session-AMBR, PCO information, or the like) or PDU session Release Command message (PDU session ID, Cause). The SMF 407 encapsulates the N1 SM message in N11 message and sends it to the AMF 405.

For example, the SMF 407 may use the Namf_Communication_N1N2MessageTransfer service operation including the N1 SM container containing PDU session Release Command or PDU session Modification Command. As the UP connection of the PDU session is not activated, the message sent by the SMF 407 to the AMF 405 shall not include N2 SM Resource Release request.

The “skip indicator” (or “N1 SM delivery skip allowed indication”) tells the AMF 405 whether it may skip sending the N1 SM container to the UE 401 (e.g. when the UE 401 is in CM-IDLE state). The AMF 405 processes the “skip indicator” for a UE 401 as described in 3GPP TS 23.502 (incorporated herein by reference). The SMF 407 may also provide N2 SM information in the N11 message to the AMF 405. This is possible in the case that the SMF 407 decides to activate the UP resources/connection for the PDU session.

At 2 (see block 408), the AMF 405 may determine to deliver the N1 SM message even though the S-NSSAI part of partially allowed NSSAI or associated with NS-AoS information. In other words, if the AMF 405 receives from the SMF 407 an N1 SM message, the AMF 405 delivers the message to the UE 401 independent on the UE 401 location being inside or outside of the area of support or availability of the PDU session's S-NSSAI.

If the AMF 405 receives from the SMF 407 an N2 SM message (e.g. for activation of UP resources), the AMF 405 needs to first determine whether the UE's 401 location is inside or outside of the area of support or availability of the PDU session's S-NSSAI. If the UE's 401 location is inside of the area of support or availability of the PDU session's S-NSSAI, the AMF 405 decides to transmit the N2 SM message to the 5G-AN 403. If the UE's 401 location is outside of the area of support or availability of the PDU session's S-NSSAI, the AMF 405 decides to reject the transmission of the N2 SM message to the 5G-AN 403. The AMF 405 sends a response to the SMF 407 indicating the failure of the transmission and an additional indication about an appropriate reason for the rejection, e.g. due to UE 401 being outside of the area of support or availability of the PDU session's S-NSSAI.

At 3a (see messaging 410), if the UE 401 is in CM-IDLE state (and “N1 SM delivery can be skipped” is not indicated), the AMF 405 may initiate the network triggered Service Request procedure to transmit the NAS message (PDU session ID, N1 SM container) to the UE 401. For this purpose the AMF 405 initiates a paging procedure to the UE 401.

At 3B (see messaging 412), the UE 401 responds to the paging procedure with a service request message. The RAN includes the current UE 401 location (e.g. TA, cell ID) in the NG-AP message from the 5G-AN which carries the service request message.

If the UE 401 is in CM-Connected state, the AMF 405 may skip 3a and 3b and continue with 4a.

At 4a (see block 414), when the UE 401 state in the AMF 405 is connected (e.g. after the AMF 405 receives the Service Request message), the AMF 405 determines whether to deliver the N2 SM message to the 5G-AN 403. If the AMF 405 has received an N2 SM message (and the current UP resources of the PDU session are not activated), the AMF 405 may determine that the SMF 407 wishes to activate the UP resources.

If the UE 401 is located outside the area of support or availability of the PDU session's S-NSSAI, the AMF 405 may determine to reject to the N2 SM message. If the UE 401 is located inside the area of support or availability of the PDU session's S-NSSAI, the AMF 405 determines to transmit the N2 SM information to the 5G-AN 403.

At 4b (see messaging 416), the AMF 405 may send Nsmf_PDUSession_UpdateSMContext service operation to the SMF 407 including an indication that the N2 SM information is rejected (i.e. not transmitted/delivered to the 5G-AN 403), and a corresponding reject cause indicating the reason for rejection (or no delivery). For example, the reject cause can indicate that the UE 401 is currently located in area where the S-NSSAI is not supported or not available.

Alternatively, if the UE 401 is located inside the area of support or availability of the PDU session's S-NSSAI, the AMF 405 includes the N2 SM information in addition to the N1 SM container in the NG-AP message sent to the 5G-AN 403 as described in 4c.

At 4c (see messaging 418), the AMF 405 creates and sends to the UE 401 a DL NAS Transport message. The DL NAS Transport message is encapsulated in NG-AP message to the 5G-AN 403. The DL NAS Transport message includes the N1 SM container which contains the NAS SM message to the UE 401. For example, the DL NAS Transport message to the UE 401 contains the PDU session information (PDU session ID) in the PDU session ID information element (IE); the Payload container type IE is set to “N1 SM information”; the Payload container IE is set to the 5GSM message; or a combination thereof.

At 5 (see block 420), the UE 401 receives the DL NAS Transport message and extracts the NAS SM message and forwards it to the correct PDU session entity in the UE 401. The NAS SM message is processed in the NAS SM instance of the NAS SM sub-layer. In general, the UE 401 performs action according the N1 SM container instruction, e.g. release/modify PDU session context. The UE 401 processes the SM message without initiating UP resource (or connection) activation. For example, if the NAS SM message indicates release of the PDU session, the UE NAS layer deletes the PDU session context internally.

At 6a (see messaging 424), the UE 401 may send N1 SM reply message to the SMF 407. The UE 401 may encapsulate the N1 SM reply message in UL NAS transport message sent to the AMF 405. For example, the N1 SM reply message is an acknowledgment of the N1 SM message received in 4c. In one example, the N1 SM reply message can be PDU session modification command ack or PDU session release command ack message.

At 6b (see messaging 426), the AMF 405 forwards the N1 SM container (PDU session Modification Command Ack) and user location information received from the AN to the SMF 407 via Nsmf_PDUSession_UpdateSMContext service operation. The SMF 407 replies with a Nsmf_PDUSession_UpdateSMContext Response.

In one embodiment, the benefit of the solution in FIG. 4 is that the network AMF 405 can determine whether to allow the activation of the UP resources of the PDU session, i.e. whether to transmit the N2 SM information to the 5G-AN 403 based on the current location of the UE 401 which is inside or outside the area of support or availability of the PDU session's S-NSSAI. Furthermore, the AMF 405 determines to transmit the N1 SM message to the UE 401 although the UE 401 is outside the area of support or availability of the S-NSSAI.

In a third embodiment, the UE may initiate either 1) a PDU session establishment procedure for a new connection or 2) Service request procedure for an already established PDU session, when the UE is located in an area where the S-NSSAI associated with the PDU session is not supported or not available. Such scenario can be either (1) an error case for a UE supporting the feature of partial support or availability of S-NSSAI or (2) the UE doesn't support the feature of partial support or availability of S-NSSAI.

Typically a UE, which supports the network slicing features “Partial Network Slice support in a Registration Area” and/or “Network Slice Area of Service not matching deployed Tracking Areas”, should not initiate the UP resource/connection activation for a PDU session when the UE is located in are outside the area of support or availability of the PDU session's S-NSSAI. However, if the UE doesn't support the feature(s) or supports the feature(s) but due to another reason requests the activation of the UP resource/connection for a PDU session, then the network (e.g. AMF or SMF) should reject the UE's request.

If the UE initiates Service Request procedure to activate the UP connection of the PDU session associated with the S-NSSAI (not supported in the current TA), the UE includes the PDU session ID in the List Of PDU sessions To Be Activated in the Service Request message. The AMF determines whether 1) the current TA (where the UE is located) is part of the list of TAs where the S-NSSAI is supported and/or 2) the current cell ID is part of the NS-AoS of the S-NSSAI. If the condition 1) and 2) are not fulfilled, then the AMF rejects the activation of the UP resources of the PDU session. For example, the AMF sends the Service Request message.

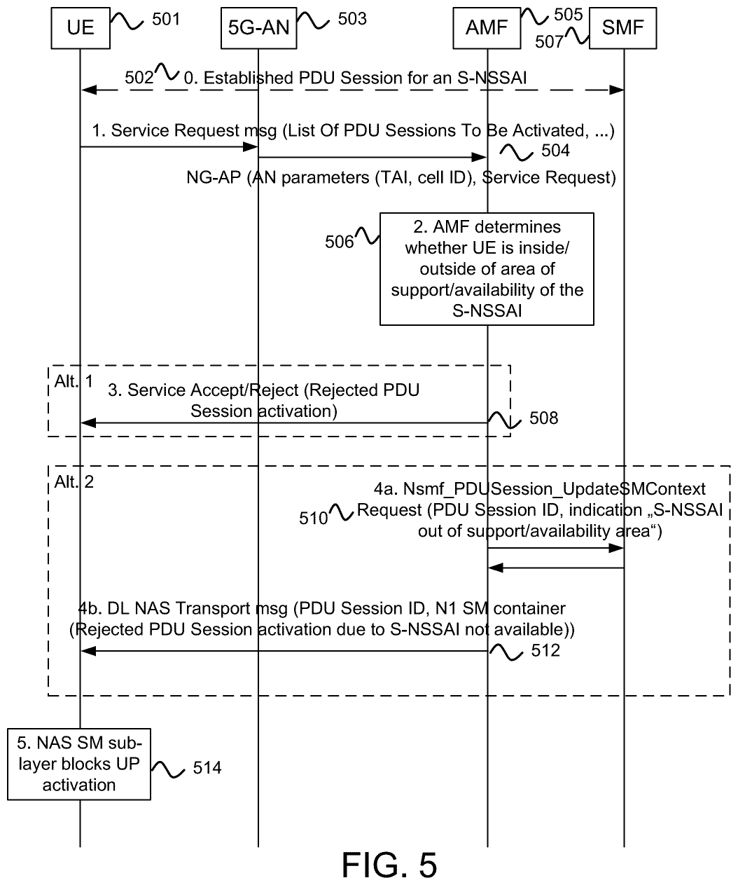

FIG. 5 illustrates an example signal flow to reject the activation of UP resources of a PDU session when the UE is outside the support/availability of the S-NSSAI in accordance with aspects of the present disclosure.

At 0 (see messaging 502), it is assumed that a PDU session is established between the UE 501 and the SMF 507. The PDU session is associated with an S-NSSAI which is partially supported in the RA (e.g. the A-NSSAI is part of the partially allowed NSSAI) or the S-NSSAI is associated with NS-AoS information (e.g. the S-NSSAI Area of Service not matching deployed Tracking Areas). In another embodiment, the UE 501 may have only registered with the S-NSSAI but hasn't established a PDU session yet.

At 1 (see messaging 504), the UE 501 initiates Service Request procedure to activate the UP connection of the PDU session associated with the S-NSSAI (not supported in the current TA), the UE 501 includes the PDU session ID in the List Of PDU sessions To Be Activated in the Service Request message.

The UE 501 sends the Service Request message to the 5G-AN 503 encapsulated in an RRC message. The 5G-AN 503 takes the Service Request message and encapsulates in N2 NG-AP message to the AMF 505. The NG-AP message includes AN parameters and the Service Request message. The AN parameters include parameters from the access network to the AMF 505, e.g. RRC establishment cause, 5G-S-TMSI or GUAMI, the cell ID or TA1 (from which the UE 501 initiates the NAS signaling).

In another scenario, the UE 501 may initiate a PDU session establishment request for an S-NSSAI with partial support or availability, e.g. assuming that the UE 501 has registered with the S-NSSAI in advance. In such a scenario, the UE 501 sends an UL NAS Transport message including a N1 SM container which contains the PDU session establishment request message. In the further description of FIG. 5, the use case of Service Request message is assumed, but the solution may also apply for the case of PDU session establishment request.

At 2 (see block 506), the AMF 505 determines that the S-NSSAI associated with the PDU session to be activated has limited support in the RA (i.e. the S-NSSAI is included in the partially allowed NSSAI and associated with list of TAs in the TA) or limited availability (i.e. the S-NSSAI is associated with NS-AoS). Then the AMF 505 needs to determine whether the UE 501 is inside/outside of area of support/availability of the PDU session's S-NSSAI.

In one embodiment, if the S-NSSAI is included in the partially allowed NSSAI and associated with list of TAs in the TA, and the current TA (where the UE 501 is located) is part of the list of TAs where the S-NSSAI is supported, the AMF 505 proceeds with the Service request procedure for activation of the UP resources of the PDU session.

In one embodiment, if the S-NSSAI is included in the partially allowed NSSAI and associated with list of TAs in the TA, and the current TA (where the UE 501 is located) is not part of the list of TAs where the S-NSSAI is supported, the AMF 505 determines to reject the Service request procedure for activation of the UP resources of the PDU session. The AMF 505 proceeds to 3.

In one embodiment, if the S-NSSAI is associated with NS-AoS and the current cell ID is part of the NS-AoS of the S-NSSAI, the AMF 505 proceeds with the Service request procedure for activation of the UP resources of the PDU session.

In one embodiment, if the S-NSSAI is associated with NS-AoS and the current cell ID is not part of the NS-AoS of the S-NSSAI, the AMF 505 determines to reject the Service request procedure for activation of the UP resources of the PDU session. The AMF 505 proceeds to 3.

At 3 (see messaging 508), which is alternative 1 for AMF-initiated rejection of the UP resource activation, the AMF 505 sends either Service Accept or Service Reject message including an indication that the requested activation of the UP resources/connection of the PDU session is rejected. The AMF 505 may include an appropriate Reject cause indicating the reason for rejection, e.g. due to network slice resources not available in the current location.

At 4a (see messaging 510), which is alternative 2 where the AMF 505 indicates to SMF 407 to initiate rejection of the UP resource activation, the AMF 505 may decide to notify the SMF 507 that the UE 501 requests PDU session activation and in addition the AMF 505 includes an indication that the S-NSSAI out of support/availability area. For example, the AMF 505 may send to the SMF 507 an Nsmf_PDUSession_UpdateSMContext Request message that includes a PDU session ID, an indication “S-NSSAI out of support/availability area”, or a combination thereof.

Upon reception of the indication that the UE 501 is an area outside of the S-NSSAI support/availability, the SMF 507 creates and transmits to the UE 501 an N1 SM container including a SM message indicating that the PDU session activation is rejected due to S-NSSAI not being supported or available.

At 4b (see messaging 512), part of alternative 2, the AMF 505 receives from the SMF 507 an N1 SM container, e.g. containing the SM message which rejects the PDU session activation due to S-NSSAI not supported/available. The AMF 505 creates and transmits a DL NAS Transport message containing a PDU session ID, an N1 SM container including an SM message indicating that the PDU session activation is rejected due to S-NSSAI not being supported or available in the current location area, or a combination thereof.

At 5 (see block 514), upon notification in 3 or 4b, the UE NAS SM sub-layer receives the N1 SM container. Based on the indication that the PDU session activation is rejected due to S-NSSAI not being supported or available in the current location area, the UE 501 blocks the transmission of user plane data (i.e. blocks the UP resource activation). In other words, the UE 501 considers the PDU session is not available for data transmission and the UE 501 may need to determine an alternative PDU session (e.g. associated with another S-NSSAI) to transmit data for the applications being associated with this PDU session.

In one embodiment, the benefit of the solution in FIG. 5 is that the network is able to determine and perform (see 2, 3, and 4) rejection of the UE's request to initiate activation of the PDU session resources based on the current UE 501 located in an area where the S-NSSAI is not supported or available.

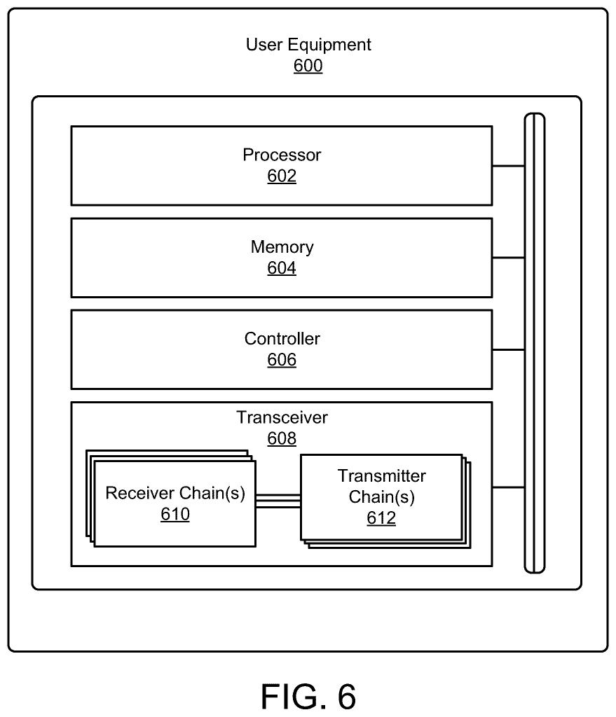

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to support a means for transmitting signaling for a SM procedure for an established PDU session associated with a network slice, wherein the network slice is not supported or not available in a location area of the UE, receiving a NAS SM message as part of the SM procedure for the PDU session, and performing an action according to the NAS SM message without initiating activation of user plane resources for the PDU session.

In one implementation, the UE 600 may be configured to or operable to support a means for proceeding with the SM procedure for the PDU session even though the UE is located in an area where single S-NSSAI is not supported or not available. In some implementations, the UE 600 may be configured to or operable to support a means for transmitting the signaling to a SMF as part of the PDU session even though the UE is located in an area where S-NSSAI is not supported or not available.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receiving the signal over the air or wireless medium. The receiver chain 610 may include at least one amplifier (e.g., a low-noise amplifier (LNA)) configured to amplify the received signal. The receiver chain 610 may include at least one demodulator configured to demodulate the received signal and obtain the transmitted data by reversing the modulation technique applied during transmission of the signal. The receiver chain 610 may include at least one decoder for decoding the processing of the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

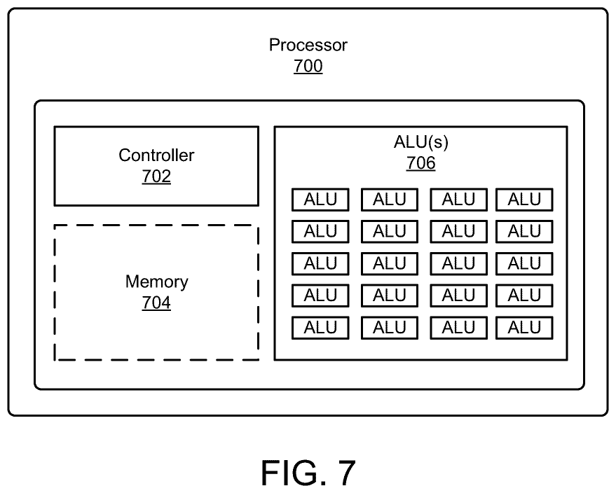

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support a means for receiving a first SM message for a PDU session associated with a network slice and a UE, means for determining that the network slice is not supported or not available in a location area of the UE, means for transmitting a second SM message and an indication that the network slice is not supported or not available in the location area of the UE.

In some implementations, the first SM message is an N1 SM message that is received from the UE and encapsulated in an uplink NAS transport message. In one implementation, the second SM message is transmitted to an SMF and encapsulated in a PDU session update request message.

In some implementations, the second SM message is an N2 SM message that is intended for an AN. In one implementation, the processor 700 is configured to cause the NE to refrain from delivering the N2 SM message to the AN in response to determining that the network slice is not supported or not available in the location area of the UE.

In some implementations, the processor 700 is configured to indicate to a sender of the first SM message that the N2 SM message was not delivered to the AN because the network slice is not supported or not available in the location area of the UE. In one implementation, the processor 700 comprises an AMF.

In one implementation, the processor 700 may be configured to or operable to support a means for transmitting signaling for a SM procedure for an established PDU session associated with a network slice, wherein the network slice is not supported or not available in a location area of the UE, receiving a NAS SM message as part of the SM procedure for the PDU session, and performing an action according to the NAS SM message without initiating activation of user plane resources for the PDU session.

In one implementation, the processor 700 may be configured to or operable to support a means for proceeding with the SM procedure for the PDU session even though the UE is located in an area where single S-NSSAI is not supported or not available. In some implementations, the processor 700 may be configured to or operable to support a means for transmitting the signaling to a SMF as part of the PDU session even though the UE is located in an area where S-NSSAI is not supported or not available.

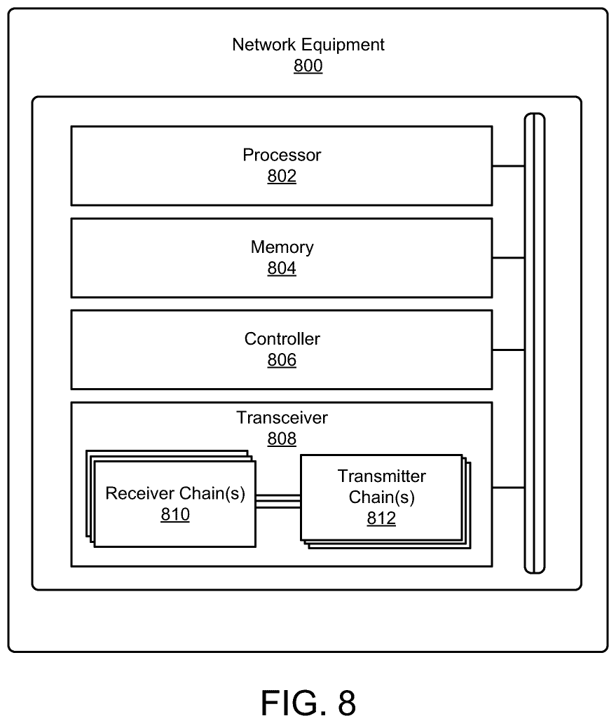

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to support a means for receiving a first SM message for a PDU session associated with a network slice and a UE, means for determining that the network slice is not supported or not available in a location area of the UE, means for transmitting a second SM message and an indication that the network slice is not supported or not available in the location area of the UE.

In some implementations, the first SM message is an N1 SM message that is received from the UE and encapsulated in an uplink NAS transport message. In one implementation, the second SM message is transmitted to an SMF and encapsulated in a PDU session update request message.

In some implementations, the second SM message is an N2 SM message that is intended for an AN. In one implementation, the NE 800 is configured to cause the NE to refrain from delivering the N2 SM message to the AN in response to determining that the network slice is not supported or not available in the location area of the UE.

In some implementations, the NE 800 is configured to indicate to a sender of the first SM message that the N2 SM message was not delivered to the AN because the network slice is not supported or not available in the location area of the UE. In one implementation, the NE 800 comprises an AMF.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

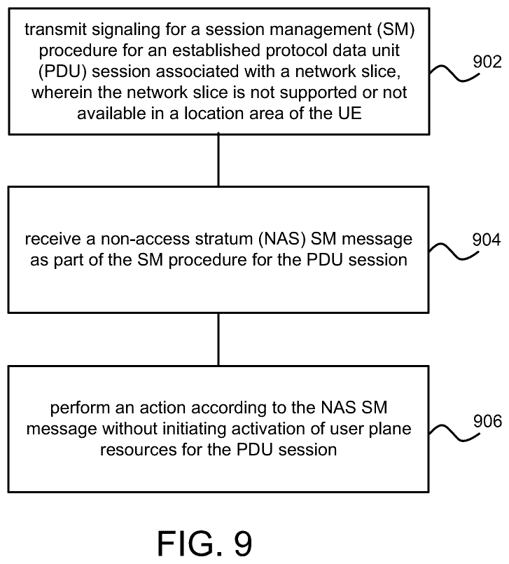

FIG. 9 illustrates a flowchart of a method in accordance with aspects of the present disclosure. The operations of the method may be implemented by a UE as described herein. In some implementations, the UE may execute a set of instructions to control the function elements of the UE to perform the described functions.

At 902, the method may include triggering an SM action for a PDU session associated with a network slice, which is not supported or not available in a location area of the UE. The operations of 902 may be performed in accordance with examples as described herein. In some implementations, aspects of the operations of 902 may be performed by a UE as described with reference to FIG. 6.

At 904, the method may include receiving a NAS SM message during the PDU session. The operations of 904 may be performed in accordance with examples as described herein. In some implementations, aspects of the operations of 904 may be performed a UE as described with reference to FIG. 6.

At 906, the method may include performing an action according to the NAS SM message without initiating user plane resources. The operations of 906 may be performed in accordance with examples as described herein. In some implementations, aspects of the operations of 906 may be performed a UE as described with reference to FIG. 6.

It should be noted that the method described herein describes a possible implementation, and that the operations and the steps may be rearranged or otherwise modified and that other implementations are possible.

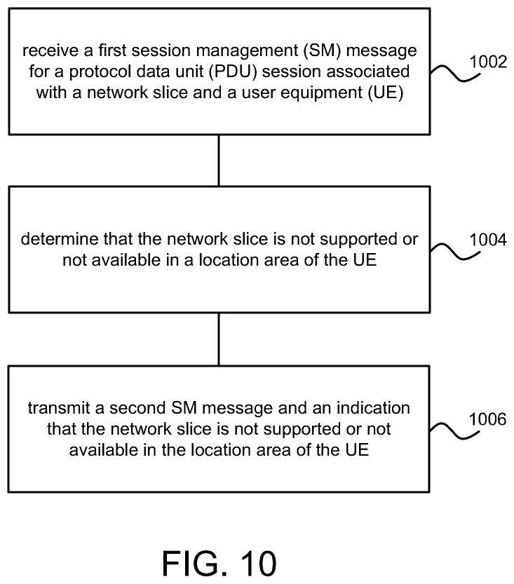

FIG. 10 illustrates a flowchart of a method in accordance with aspects of the present disclosure. The operations of the method may be implemented by a NE as described herein. In some implementations, the NE may execute a set of instructions to control the function elements of the NE to perform the described functions.

At 1002, the method may include receiving a first SM message for a PDU session associated with a network slice and a UE. The operations of 1002 may be performed in accordance with examples as described herein. In some implementations, aspects of the operations of 1002 may be performed by a NE as described with reference to FIG. 8.

At 1004, the method may include determining that the network slice is not supported or not available in a location area of the UE. The operations of 1004 may be performed in accordance with examples as described herein. In some implementations, aspects of the operations of 1004 may be performed by a NE as described with reference to FIG. 8.

At 1006, the method may include transmitting a second SM message and an indication that the network slice is not supported or not available in the location area of the UE. The operations of 1006 may be performed in accordance with examples as described herein. In some implementations, aspects of the operations of 1006 may be performed a NE as described with reference to FIG. 8.

It should be noted that the method described herein describes A possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity (NE), comprising:
at least one memory; and
at least one processor coupled with the at least one memory and configured to cause the NE to:
receive a first session management (SM) message for a protocol data unit (PDU) session associated with a network slice and a user equipment (UE);
determine that the network slice is not supported or not available in a location area of the UE; and
transmit a second SM message and an indication that the network slice is not supported or not available in the location area of the UE.

2. The NE of claim 1, wherein:
the first SM message is an N1 SM message that is received from the UE and encapsulated in an uplink non-access stratum (NAS) transport message.

3. The NE of claim 2, wherein:
the second SM message is transmitted to a session management function (SMF) and encapsulated in a PDU session update request message.

4. The NE of claim 1, wherein:
the second SM message is an N2 SM message that is intended for an access network (AN).

5. The NE of claim 4, wherein:
the at least one processor is configured to cause the NE to refrain from delivering the N2 SM message to the AN in response to determining that the network slice is not supported or not available in the location area of the UE.

6. The NE of claim 5, wherein:
the at least one processor is configured to cause the NE to indicate to a sender of the first SM message that the N2 SM message was not delivered to the AN because the network slice is not supported or not available in the location area of the UE.

7. The NE of claim 1, wherein:
the NE comprises an Access and Mobility Management Function (AMF).

8. A processor for wireless communication, comprising:
at least one controller coupled with at least one memory and configured to cause the processor to:
receive a first session management (SM) message for a protocol data unit (PDU) session associated with a network slice and a user equipment (UE);
determine that the network slice is not supported or not available in a location area of the UE; and
transmit a second SM message and an indication that the network slice is not supported or not available in the location area of the UE.

9. The processor of claim 8, wherein:
the first SM message is an N1 SM message that is received from the UE and encapsulated in an uplink non-access stratum (NAS) transport message.

10. The processor of claim 9, wherein:
the second SM message is transmitted to a session management function (SMF) and encapsulated in a PDU session update request message.

11. The processor of claim 8, wherein:
the second SM message is an N2 SM message that is intended for an access network (AN).

12. The processor of claim 11, wherein:
the at least one controller is configured to cause the processor to refrain from delivering the N2 SM message to the AN in response to determining that the network slice is not supported or not available in the location area of the UE.

13. The processor of claim 12, wherein:
the at least one controller is configured to cause the processor to indicate to a sender of the first SM message that the N2 SM message was not delivered to the AN because the network slice is not supported or not available in the location area of the UE.

14. The processor of claim 8, wherein:
the processor comprises an Access and Mobility Management Function (AMF).

15. A method performed by a network function, the method comprising:
receiving a first session management (SM) message for a protocol data unit (PDU) session associated with a network slice and a user equipment (UE);
determining that the network slice is not supported or not available in a location area of the UE; and
transmitting a second SM message and an indication that the network slice is not supported or not available in the location area of the UE.

16. The method of claim 15, wherein:
the first SM message is an N1 SM message that is received from the UE and encapsulated in an uplink non-access stratum (NAS) transport message.

17. The method of claim 16, wherein:
the second SM message is transmitted to a session management function (SMF) and encapsulated in a PDU session update request message.

18. A user equipment (UE) for wireless communication, comprising:
at least one memory; and
at least one processor coupled with the at least one memory and configured to cause the UE to:
transmit signaling for a session management (SM) procedure for an established protocol data unit (PDU) session associated with a network slice, wherein the network slice is not supported or not available in a location area of the UE;
receive a non-access stratum (NAS) SM message as part of the SM procedure for the PDU session; and
perform an action according to the NAS SM message without initiating activation of user plane resources for the PDU session.

19. The UE of claim 18, wherein:
the at least one processor is configured to cause the UE to proceed with the SM procedure for the PDU session even though the UE is located in an area where single network slice selection assistance information (S-NSSAI) is not supported or not available.

20. The UE of claim 19, wherein:
the at least one processor is configured to cause the UE to transmit the signaling to a session management function (SMF) as part of the PDU session even though the UE is located in an area where S-NSSAI is not supported or not available.
